(19) United States
(12) Patent Application Publication
(10) Pub. No.: US 2024/0262024 A1
(43) Pub. Date: Aug. 8, 2024

(54) Injection Molding Machine with Sensor-Supported Machine Parameter Control and a Method for Sensor-Supported Machine Parameter Control of Injection Molding Processes

(71) Applicant: NETZSCH Process Intelligence GmbH, Selb (DE)

(72) Inventors: Alexander Chaloupka, Ingenried (DE); Nicholas Ecke, Baldham (DE); Prof. Sascha Englich, Chemnitz (DE); Josef Ketels, München (DE); John Puentes, München (DE); Ingo Schwarz, Gilching (DE)

(21) Appl. No.: 18/425,513

(22) Filed: Jan. 29, 2024

(30) Foreign Application Priority Data
Feb. 3, 2023 (DE) 10 2023 102 706.9

(51) Int. Cl. B29C 45/78; B29C 45/76; B29C 45/77; B29K 105/26

(52) U.S. Cl. CPC B29C 45/78; B29C 45/7653; B29C 45/77; B29C 2945/76006; B29C 2945/7604; B29C 2945/7618; B29K 2105/26

(57) ABSTRACT

An injection molding machine includes a plasticizing unit having a plasticizing cylinder and a material-conveying device that is movable in the plasticizing cylinder and powered by a material-conveying drive, a material-conveying drive control, which is coupled with the material-conveying drive and is designed to control operating parameters of the material-conveying drive, a closing unit having an injection molding tool that is connected with an outlet nozzle of the plasticizing cylinder, as well as a closing unit control, which is coupled with a closing unit drive of the closing unit and is designed to control operating parameters of the closing unit drive. The injection molding machine further includes one or more dieletric or acoustic sensors which are disposed in the cavity of the injection molding tool or close to the cavity of the injection molding tool and are designed to determine the dielectric polarizability, mobility of free load carriers and/or acoustic material responses of a molding material in the cavity of the injection molding tool. A sensor control is coupled with the dielectric or acoustic sensor(s) and is designed to ascertain a time-dependent degree of crystallization and a time-dependent median temperature of the molding material in the cavity of the injection molding tool from the dielectric polarizability, mobility of free load carriers and/or acoustic material responses determined by the dielectric sensor(s) and, depending on the ascertained degree of crystallization and the ascertained median temperature, to actuate the material-conveying drive control and/or the closing unit control to adjust the operating parameters of the material-conveying drive and/or of the closing unit drive.

### TECHNICAL FIELD

This invention relates to an injection molding machine, the machine parameters of which can be dynamically adjusted during the injection molding process by sensor-supported real-time in-line monitoring, as well as a method for dynamic control of machine parameters during the injection molding process by sensor-supported real-time in-line monitoring, in particular by in-situ sensor monitoring of process variables of a process simulation model and simultaneous algorithmic adjustment of the process simulation model on the basis of sensor monitoring.

Although it can also be employed in every type of injection molding machine, for example thermoplastic injection molding machines, duroplastic injection molding machines or elastomer injection molding machines, this invention and the corresponding problems which it aims to solve are explained in greater detail in connection with injection molding processes of semi-crystalline thermoplastics. Forms of implementation of this invention can also be applied not only in connection with injection molding machines but also resin injection machines, resin infusion machines, in compression molding processes, in extrusion or pultrusion processes, in extrusion blow molding as well as in taping processes.

Ensuring production of components with low rejection rates in plastics injection molding processes depends essentially on guaranteeing the material stability of the material to be processed, closely accompanied by adjustable process management.

Because it is impossible to exclude variations in material composition and in material behavior during the injection molding process—caused for example by variation in the mixing proportions, the filler material or additives content, the aging, the retention time of the injection molding material in the machine before and during the injection molding process, and/or mechanical influences during the processing as well as by variation in the raw components, by variations in the transport and/or warehousing stability as well as other unknown process influences—it is desirable to be able to adjust the process management flexibly to these external factors.

The trend in the plastics industry is toward an increase in the portion of recyclates added in the processing of thermoplastic materials. In these types of source materials, because the history of the employed recyclate material is often unknown or not ascertainable with sufficient precision, an increase in variations in material composition and in material behavior is to be expected. These variations add further to the already expected material, environmental and process fluctuations, and thus it is essential to expect strong variations in the melt condition inside the plasticizing cylinder of an injection molding machine accompanied by strong modifications in the filling and cooling/solidifying/hardening behavior in the tool, for example upon injection, connection, crystallization and/or stabilization of amorphous thermoplastics. In the case of thermoplastics with recyclate contents, the type and mixing ratios of the thermoplastics, processing history of the recyclates (exposure to environmental influences such as chemicals or temperature fluctuations), recyclate generation of the various recyclate portions as well as of mechanical influences during the preceding processing of the recyclates have a role in the control of injection molding processes.

Industrial production of plastic components, however, is dependent on reproducible control of the solidifying or crystallizing behavior of the employed materials, because the properties of the end product rely strongly on the conditions of the hardening process. Therefore it is desirable to be in a position of being able to react dynamically in real time to fluctuations in the solidification or crystallization behavior in each individual process of this kind.

At least a few of these goals are achieved by means of the content of the respective independent claims. Advantageous embodiments are described in the subsidiary claims, which are related to the independent claims.

### SUMMARY

According to a first aspect of the invention, an injection molding machine comprises a plasticizing unit having a plasticizing cylinder and a material-conveying device that is movable in the plasticizing cylinder and is powered by a material-conveying drive, a material-conveying drive control, which is coupled with the material-conveying drive and is designed to control operating parameters of the material-conveying drive, a closing unit having an injection molding tool that is connected with an outlet nozzle of the plasticizing cylinder, as well as a closing unit control which is coupled with a closing unit drive of the closing unit and is designed to control operating parameters of the closing unit drive. One or more dielectric or acoustic sensors are disposed in the cavity of the injection molding tool or close to the cavity of the injection molding tool and are designed to determine the dielectric polarizability, mobility of free load carriers and/or acoustic material responses of a molding material in the cavity of the injection molding tool. The injection molding machine further comprises a sensor control, which is coupled with the dielectric or acoustic sensor(s) and is designed to ascertain a time-dependent degree of crystallization and a time-dependent median temperature of the molding material in the cavity of the injection molding tool from the dielectric polarizability, mobility of free load carriers and/or acoustic material responses determined by the dielectric or acoustic sensor(s) and, depending on the ascertained crystallization degree and the ascertained median temperature, to actuate the material-conveying drive control and/or the closing unit control to adjust the operating parameters of the material-conveying drive and/or of the closing unit drive.

The injection molding machine in this case can be a screw injection molding machine which, as a material-conveying device, comprises a screw shaft rotating in the plasticizing cylinder and powered by a screw drive, and whose material-conveying drive is a screw drive. A screw drive control is coupled with the screw drive and is designed to control operating parameters of the screw drive.

Alternatively, the injection molding machine can be a piston injection molding machine which, as material-conveying device, comprises a piston, which can be moved in a sliding manner within the plasticizing cylinder and is powered by a piston drive, and whose material-conveying drive is a piston drive. A piston drive control is coupled with the piston drive and designed to control operating parameters of the piston drive.

According to a second aspect of the invention, a method for dynamic control of machine parameters by sensor-supported real-time in-line monitoring in an injection molding machine with a material-conveying device and a closing unit includes the following steps: determination of dielectric polarizability, mobility of free load carriers and/or acoustic material responses of a molding material in a cavity of a tool of an injection molding machine by means of one or more dielectric or acoustic sensors, which are disposed in the cavity of the injection molding tool or close to the cavity of the injection molding tool; ascertaining of a time-dependent degree of crystallization and of a time-dependent median temperature of the molding material in the cavity of the injection molding tool from the dielectric polarizability, mobility of free load carriers and/or acoustic material responses determined by the dielectric or acoustic sensor(s); and adjustment of operating parameters of a material-conveying drive of the material-conveying device and/or of a closing unit drive of the closing unit, depending on the ascertained crystallization degree and the ascertained median temperature.

According to a few of the embodiments of the first or second aspect of the invention, the material-conveying drive is a screw drive and the material-conveying device is a screw shaft, while the operating parameters of the screw drive include the screw shaft momentum, screw shaft rotation rate, injection speed, injection volume, switchover point and/or injection holding pressure.

According to a few additional embodiment of the first or second aspect of the invention, the operating parameters of the closing unit include the tool closing force, the back pressure and/or the tool heating capacity.

According to an additional embodiment of the first or second aspect of the invention, the molding material in the tool's cavity comprises a portion of at least 1 vol %, in particular at least 10 vol %, in particular at least 15 vol %, in particular at least 20 vol %, and in particular at least 25 vol % recyclate material, in particular pre-consumer recyclate material or post-consumer recyclate material.

According to a few embodiments of the first aspect of the invention, the injection molding machine can, in addition, comprise one or more temperature sensors, which are disposed in the cavity of the injection molding tool, close to the cavity of the injection molding tool and/or on the plasticizing cylinder.

According to a few embodiments of the first aspect of the invention, the injection molding machine can, in addition, comprise one or more pressure sensors, which are disposed in the cavity of the injection molding tool, close to the cavity of the injection molding tool and/or on the plasticizing cylinder. In some implementation forms, the pressure sensors can include differential thermal analysis sensors. In some other implementation forms, the pressure sensors can include differential thermal analysis sensors. In some other implementation forms, the injection molding machine can include separate differential thermal analysis sensors, which are disposed in the cavity of the injection molding tool, close to the cavity of the injection molding tool and/or on the plasticizing cylinder.

According to a few additional embodiments of the second aspect of the invention, the method can in addition comprise a step for ascertaining the temperature of the molding material in a plasticizing cylinder of the injection molding machine and/or in the cavity of the injection molding tool by means of one or more temperature sensors, which are disposed in the cavity of the injection molding tool, close to the cavity of the injection molding tool and/or on the plasticizing cylinder.

According to a few additional embodiments of the second aspect of the invention, the method can also comprise a step for ascertaining pressure of the molding material in a plasticizing cylinder of the injection molding machine and/or in the cavity of the injection molding tool, by means of one or more pressure sensors, which are disposed in the cavity of the injection molding tool, close to the cavity of the injection molding tool, and/or on the plasticizing cylinder. In some implementation forms, the pressure sensors can include differential thermal analysis sensors. In other implementation forms the injection molding machine can include differential thermal analysis sensors which are disposed in the cavity of the injection molding tool, close to the cavity of the injection molding tool and/or on the plasticizing cylinder.

According to a few additional embodiments of the first or second aspect of the invention, additional acoustic sensors can be foreseen in the cavity of the injection molding tool or in the plasticizing cylinder in order to determine the acoustic material behavior of the molding material or of the synthetic raw material, which can be indicative of the degree of crystallization, the median density, the median temperature as well as the internal mold pressure.

### BRIEF DESCRIPTION OF THE DRAWINGS

The invention will be described in greater detail with reference to the exemplary embodiments that are illustrated in the annexed drawings.

The enclosed drawings are provided in order to allow further understanding of this invention and are included in this description, constituting a part thereof. The drawings illustrate the embodiments of this invention and, in combination with the description, serve to clarify the principles of the invention. Other embodiments of this invention and many of the foreseen advantages of this invention are easily understandable when they become clearer by reference to the following detailed description. The elements of the drawings are not necessarily drawn to the same scale with one another. The same reference numbers designate corresponding similar parts.

FIG. 1 schematically illustrates an injection molding machine whose machine parameters can be dynamically adjusted during the injection molding process by sensor-supported real-time in-line monitoring according to an exemplary embodiment of the invention;

FIG. 2 schematically sketches an exemplary PVT diagram of semi-crystalline thermoplastics, which can be employed as the basis for regulating an injection molding process, as well as a period of time of the operating pressure in an injection molding machine according to an exemplary embodiment of the invention; and

FIG. 3 schematically illustrates a flow chart of stages in a method for dynamic control of machine parameters by sensor-supported real-time in-line monitoring during the injection molding process, according to an exemplary embodiment of the invention.

Identical reference numbers in the illustrations designate identical or functionally similar components, unless otherwise indicated. All designations of position, such as “above,” “below,” “at left,” “at right,” “over,” “under,” “horizontal,” “vertical,” “behind,” “in front” and similar terms are employed only for purposes of clarification and are not intended to restrict the embodiments to specific arrangements that are indicated in the drawings.

### DETAILED DESCRIPTION

Even where specific embodiments have been illustrated and described herein, it is to be understood by practiced specialists that the specific embodiments shown and described can be replaced by a number of alternative and/or equivalent adaptations without departing from the domain of protection of the present invention. In general, this application is intended to cover all adaptations or variations of the specific embodiments that are described herein.

Recyclates as employed in the present publication include all secondary raw materials that are obtained in recycling synthetic wastes, such as for example from PE (polyethylene), PP (polypropylene) or PET (polyethylene terephthalate). Recyclates can be added as grist, regranulate and/or regenerate to a primary material in variable portions, for example to at least 1 vol %, at least 10 vol %, at least 15 vol %, at least 20 vol % or at least 25 vol % and used to produce new end products.

Post-consumer recyclates can be included in the end products of synthetics production by means of pyrolytic decomposition and, through the impact of warmth, catalyzers as well as dissolution means, the polymer chains of synthetics waste can be decreased and split off all the way to monomers. Thereafter, from the obtained basic components, new synthetic raw material can be refined as recyclate. Alternatively, post-consumer recyclates can also be obtained from end users' refuse, in that the waste is collected, sorted by synthetics type (PP, PE, PS), and then ground up, washed and melted down into new synthetics granulate material.

Recyclates obtained by mechanical means have a little-known history concerning a recent injection molding process, and thus, because of strong demands on construction quality, particular attention in injection molding processes must be paid to the material quality fluctuations that are to be expected.

Pre-consumer recyclates can be produced from industrial waste, which occurs primarily during ongoing production processes or during the start-up of production installations as sprues, scrap or cutoffs. These pre-consumer recyclates occur primarily in greater amounts and unsorted, and thus can be ground up and then reused without major sorting or cleansing expense.

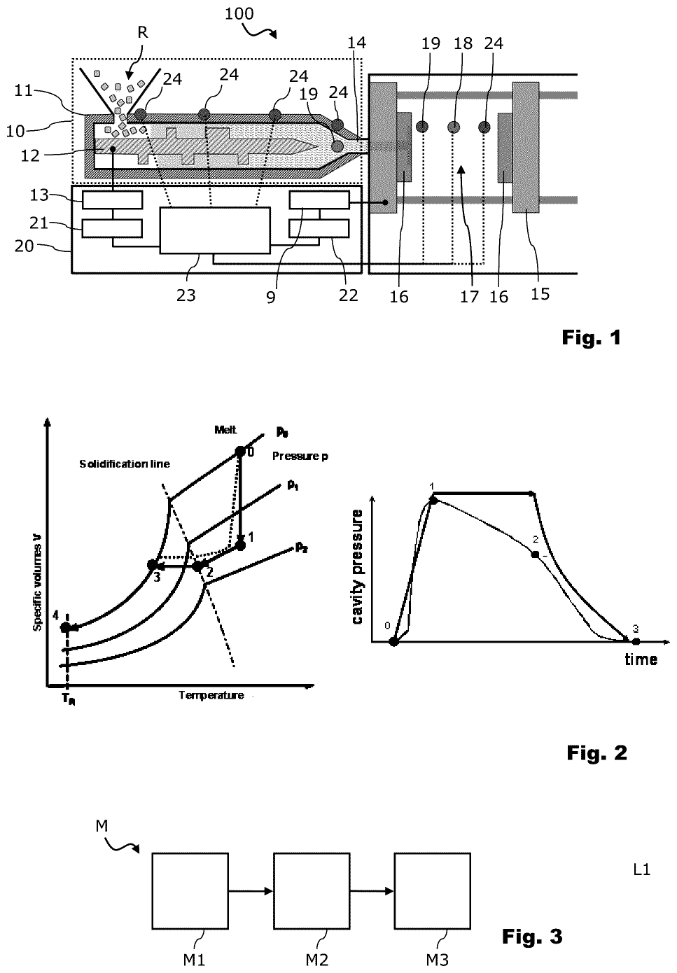

FIG. 1 schematically illustrates an injection molding machine 100 according to an embodiment of the present invention. The injection molding machine 100 serves to produce directly usable synthetics components produced from a synthetics raw material R, such as pellets for example. In particular, the synthetics raw material R can comprise a particular portion of recyclate material such as post-consumer recyclate material or pre-consumer recyclate material, for example at least 1 vol %, at least 10 vol %, at least 15 vol %, at least 20 vol % or at least 25 vol %.

The injection molding machine 100 comprises as essential predominant functional components a plasticizing unit 10 having a plasticizing cylinder 11 as well as a closing unit 15. In the closing unit 15 an injection molding machine 16 can be placed, which is connected with the plasticizing cylinder 11 of the plasticizing unit 10 by an outlet nozzle 14 of the plasticizing cylinder 11. The functional components of the injection molding machine 100 are actuated by corresponding control modules in a machine control module 20 of the injection molding machine 100.

The injection molding machine 100 of FIG. 1 is depicted by way of example as a screw injection molding machine. Therefore the injection molding machine 100 comprises a rotating screw shaft 12 disposed in the plasticizing cylinder 11. The screw shaft 12 is powered by a screw drive 13 as material-conveying device, which in turn is powered by a screw drive control 21. The screw drive control 21 can establish or adjust operating parameters of the screw drive 13, such as a screw shaft momentum, a screw shaft rotation rate, an injection speed of the screw shaft, the time period of an injection volume and/or an injection holding pressure. The screw shaft 12 thereby conveys synthetics material R through the plasticizing cylinder 11 and through the outlet nozzle 14 into a cavity 17, which is configured by matrices (e.g., possibly cores and/or patrices) of the injection molding tool 16.

Alternatively, the injection molding machine 100 can also be a piston injection molding machine, which instead of the screw shaft 12 comprises a piston 12, which can be moved within the plasticizing cylinder 11 by sliding and is powered by a piston drive 13. The drive control in this case can be a piston drive control 21, which is coupled with the piston drive 13 as material-conveying drive and is designed to control operating parameters of the piston drive 13, such as a propulsion speed of the piston, the time period of an injection volume, an injection pressure and/or an injection holding pressure.

The closing unit 15 is powered by a closing unit drive 9, which in turn is powered by a closing unit control 22. The closing unit control 22 can establish or adjust operating parameters of the closing unit drive 9, such as a tool closing force, a back pressure and/or a tool heating capacity.

Fundamental operating parameters of the injection molding machine 100, such as in particular the closing unit drive 9 and the material-conveying drive 13, can be determined by way of approximate formulas or simulations. Purely tool-dependent parameters such as, for instance, switchover points as well as holding pressure periods and holding pressure profiles, can be determined by specific experimental protocols. Basic settings determined in this way for the operating parameters define the approximate processing window, but hitherto take no account of any variations in the respective individual process itself, in particular no aberrations in the specific nature and history of the employed synthetics material R. This applies even more for synthetics raw materials R having a not negligible recyclate portion.

Machine and processing conditions can be adjusted so that machine signals are correlated with theoretical material properties. For this purpose, use is made, for example, of the momentum of the material-conveying drive 13 to estimate the material viscosity of the partly or completely plasticized synthetics raw material R or to determine the median base temperature of the synthetics raw material R using the plasticizing capacity applied by the material-conveying drive 13 and the injection speed. All these approaches demand homogeneous conditions and neglect relevant actual processes, so that the result merely constitutes a rough estimation.

FIG. 2 schematically depicts an exemplary PVT diagram of semi-crystalline thermoplastics, which can be used as basis for regulating an injection molding process, as well as the time period of the operating pressure in the cavity of an injection molding tool in a closing unit of an injection molding machine, such as for instance the injection molding machine 100 explained in association with FIG. 1.

In a first processing step 0→1, a melted thermoplastic is compressed inside a cavity 17 of an injection molding tool 16 of an injection molding machine 100 at fixed temperature. Thereafter, in a processing step 1→2, an isobaric cooling occurs until the melted material undergoes a phase transition into the semi-crystalline state. The following processing step 2→3 is then an isochoric cooling, until the environmental pressure p₀ is reached. Thereafter the end product in the injection molding tool 16 can be further cooled in a processing step 3→4 at environmental pressure.

The theoretical or optimal course is depicted above the solid line in the PVT diagram. However, the chemical-physical material modification as well as its condition at the beginning of the manufacturing process (historical material modification caused by material fluctuations, environmental conditions during storage, holding period at heightened thermal influence, etc.), influence the behavior of the viscosity, the crystallization or degree of solidification of the thermoplastic. In fact, the process steps therefore take a different course, as for example indicated by the broken line.

The chemical-physical material modification as well as material fluctuations in the raw material should therefore actually be taken into consideration for a process regulation aimed at a constant component quality.

For this purpose the injection molding machine 100 includes one or more dielectric or acoustic sensors 18, which are disposed in the cavity 17 of the injection molding tool 16 or close to the cavity of the injection molding tool 16. The dielectric sensors 18 can determine the dielectric polarizability or the mobility of free load carriers of the molding material S in the cavity 17 of the injection molding tool 16. The measurements ascertained by the one or more dielectric or acoustic sensors 18 in or close to the cavity 17 of the injection molding tool 16 generally indicate physical properties of the molding material S which is found in the cavity 17 and is processed in the injection molding machine 100. Such physical properties, besides the dielectric polarizability, can also include, for example, the dielectricity constant, permittivity, impedance, phase angle, dielectric polarizability, the dielectric loss factor, the ion conducting capacity, visco-elastic properties, dynamic coefficients, glass transition temperatures, crystallization temperatures, sublimation temperatures or ion viscosity. These physical parameters can be determined by means of measurement of dipolar polarization and ion migration models. The dielectric sensors, for example, can comprise interlocked electrode sensors, Monotrode sensors or plate electrode capacitance sensors. Acoustic sensors can comprise, for instance, ultrasound sensors to determine the sound speed, the muting, density or temperature of the molding material as well as the internal mold pressure.

It is also possible, thereafter or alternatively, to employ other sensor types such as additional ultrasonic sensors, pressure sensors 19, temperature sensors 24, dynamic-mechanical sensors, voltmeters, differential-thermic sensors or others. Only one dielectric sensor 18, or only one pressure sensor 19 and one temperature sensor 24, are explicitly depicted in FIG. 1, but it is understood that several sensors of the same or a similar type, of different sensitivity and reusability, can also be implemented.

The dielectric or acoustic sensors 18, as well as other sensors 19 and/or 24 in some cases, are coupled with a sensor control 23 of the machine control module 20. The sensor control 23 acquires and processes the measurement values of all sensors 18, 19 and 24, so that a time-dependent degree of crystallization and a time-dependent median temperature of the molding material S in the cavity 17 of the injection molding tool 16 can be ascertained from the determined dielectric polarizability or the mobility of free load carriers. The time-dependent median temperature can be determined, for example, by the condition of the dielectrical polarizability applied over the measured temperature. In addition, dielectric polarizability offers a response comparable to a mechanical material response under deformation stress. The degree of crystallization and median temperature can likewise be inferred from acoustic material responses.

Depending on the ascertained crystallization degree and the ascertained median temperature, the sensor control 23 can then actuate the material-conveying drive control 21 to adjust the operating parameters of the material-conveying drive 12 and/or the closing unit control 22 to adjust the operating parameters of the closing unit drive 9.

As a result, operating parameters of the essential functional components of the injection molding machine 100 can be adjusted in real time in order to ensure foreseeable and constant component quality of the injection molding end products despite existing fluctuations in material behavior, environmental conditions and process properties. In particular, this can be guaranteed by ascertaining material parameters in situ, that is, within the cavity 17, because modifications in filling behavior as well as in cooling/hardening behavior (injection mass, crystallization speed, degree of crystallinity, solidification of amorphous thermoplastics, real mass temperature) can be tracked directly in or close to the injection molding tool 16.

In addition to the sensors 18, 19, 24 in the cavity 17 of the injection molding tool 16 or close to the cavity 17 of the injection molding tool 16, the sensor control 23 can draw on further measurement values from pressure sensors 19 or temperature sensors 24 at or in the plasticizing cylinder 11. Thus, it becomes possible for the adjustments of the operating parameters also to include modifications of the melting condition in the plasticizing cylinder 11, that is, variations in the melting density as a result of modified temperature and/or viscosity conditions. The pressure sensors 19, for example, can be configured as differential thermal analysis sensors, or separate differential thermal analysis sensors can be employed.

FIG. 3 schematically illustrates a flow chart of stages of a method M for dynamic control of machine parameters by sensor-supported real-time in-line monitoring in an injection molding machine. The method M, in particular, can be implemented in the injection molding machine 100, as is illustrated in association with FIG. 1.

In a first step M1, dielectric polarizability of a molding material S in a cavity 17 of an injection molding tool 16 of an injection molding machine 100 is determined by one or more dielectric or acoustic sensors 18. The dielectric or acoustic sensors 18 can be disposed in the cavity 17 of the injection molding tool 16 or close to the cavity 17 of the injection molding tool 16.

In a second step M2, a time-dependent degree of crystallization and a time-dependent median temperature of the molding material S in the cavity 17 of the injection molding tool 16 are ascertained from the dielectric polarizability and mobility of free load carriers determined by the electric sensors 18. This determined dielectric polarizability, mobility of free loading carriers or acoustic material response can be used in a third step M3 and can provide a basis for adjusting or controlling operating parameters of a material-conveying drive 13 of a material-conveying device 12 of the injection molding machine 100 and/or of a closing unit drive 9 of a closing unit 15 of the injection molding machine 100.

In the foregoing detailed description, various characteristics are grouped together in one or more examples with the purpose of streamlining the presentation. It is understood that the foregoing description is to be considered as illustrative rather than restrictive. It is intended to cover all alternatives, modifications and equivalences. Many other examples will be familiar to a specialist who considers the foregoing description.

The embodiments have been selected and described in order to explain as well as possible the principles of the invention and its practical applications, and thereby to enable other specialists to make the best possible use of the invention and various embodiments with diverse modifications, as appropriate for the specially considered use. In the included claims and the description, the terms “containing” and “in that” as employed as simple language devices for the appropriate terms “including” or “in which.” Moreover, “one” in the present instance does not exclude “several.”

1. An injection molding machine including:
a plasticizing unit having a plasticizing cylinder and a material-conveying device that is movable in the plasticizing cylinder and powered by a material-conveying drive;
a material-conveying drive control, which is coupled with the material-conveying drive and is designed to control operating parameters of the material-conveying drive;
a closing unit having an injection molding tool that is connected with an outlet nozzle of the plasticizing cylinder;
a closing unit control, which is coupled with a closing unit drive of the closing unit and is designed to control operating parameters of the closing unit drive;
one or more dielectric or acoustic sensors, which are disposed in the cavity of the injection molding tool or close to the cavity of the injection molding tool and designed to determine the dielectric polarizability, the mobility of free loading carriers and/or acoustic material responses of a molding material in the cavity of the injection molding tool; and
a sensor control, which is coupled with the dielectric or acoustic sensor(s) and designed to ascertain a time-dependent degree of crystallization and a time-dependent median temperature of the molding material in the cavity (2) of the injection molding tool from the dielectric polarizability, the mobility of free loading carriers and/or the acoustic material responses determined by the dielectric or acoustic sensor(s) and, depending on the ascertained crystallization degree and the ascertained median temperature, to actuate the material-conveying device control and/or the closing unit control to adjust the operating parameters of the material-conveying drive and/or of the closing unit drive.

2. The injection molding machine according to claim 1, wherein the material-conveying drive is a screw drive and the material-conveying device is a screw shaft, and wherein the operating parameters of the screw drive include the screw shaft momentum, screw shaft rotation rate, injection speed, injection volume, switchover point and/or injection holding pressure.

3. The injection molding machine according to claim 1, wherein the operating parameters of the closing unit drive include the tool closing force, the internal mold pressure and/or the tool heat capacity.

4. The injection molding machine according to claim 1, wherein the molding material in the cavity of the injection molding tool comprises a portion of at least 1 vol %, in particular at least 10 vol %, in particular at least 15 vol %, in particular at least 20 vol %, and in particular at least 25 vol % recyclate material, in particular pre-consumer recyclate material or post-consumer recyclate material.

5. The injection molding machine according to claim 1, further including:
one or more temperature sensors, which are disposed in the cavity of the injection molding tool, close to the cavity of the injection molding tool and/or on the plasticizing cylinder (11).

6. The injection molding machine according to claim 1, further including:
one or more pressure sensors, which are disposed in the cavity of the injection molding tool, close to the cavity of the injection molding tool and/or on the plasticizing cylinder.

7. The injection molding machine according to claim 6, wherein the one or more pressure sensors include differential thermal analysis sensors.

8. A method for dynamic control of machine parameters by sensor-supported real-time in-line monitoring in an injection molding machine having a material-conveying device and a closing unit, said method including the following steps:
determining a dielectric polarizability, a mobility of free loading carriers and/or acoustic material responses of a molding material a cavity of an injection molding tool of an injection molding machine by one or more dielectric or acoustic sensors, which are disposed in the cavity of the injection molding tool or close to the cavity of the injection molding tool;
ascertaining (of a time-dependent degree of crystallization and of a time-dependent median temperature of the molding material in the cavity of the injection molding tool from the dielectric polarizability, mobility of free load bearers and/or acoustic material responses determined by the dielectric or acoustic sensor(s); and
adjusting operating parameters of a material-conveying drive of the material-conveying device and/or of a closing unit drive of the closing unit, depending on the ascertained degree of crystallization and the ascertained median temperature.

9. The method according to claim 8, wherein the material-conveying drive is a screw drive and the material-conveying device is a screw shaft, and wherein the operating parameters of the screw drive include the screw shaft momentum, screw shaft rotation rate, injection speed, injection volume, switchover point and/or injection holding pressure.

10. The method according to claim 8, wherein the operating parameters of the closing unit drive include the tool closing force, the internal mold pressure and/or the tool heat capacity.

11. The method according to claim 8, wherein the molding material in the cavity of the injection molding tool comprises a portion of at least 1 vol %, in particular at least 10 vol %, in particular at least 15 vol %, in particular at least 20 vol %, and in particular at least 25 vol % recyclate material, in particular pre-consumer recyclate material or post-consumer recyclate material.

12. The method according to claim 8, with the additional step of ascertaining a temperature of the molding material in a plasticizing cylinder of the injection molding machine and/or in the cavity of the injection molding tool by one or more temperature sensors, which are disposed in the cavity of the injection molding tool, close to the cavity of the injection molding tool and/or on the plasticizing cylinder.

13. The method according to claim 8, with the additional step of ascertaining a pressure of the molding material in a plasticizing cylinder of the injection molding machine and/or in the cavity of the injection molding tool by one or more pressure sensors, which are disposed in the cavity of the injection molding tool, close to the cavity of the injection molding tool and/or on the plasticizing cylinder.

14. The method according to claim 13, wherein the one or more pressure sensors include differential thermal analysis sensors.

15. The injection molding machine according to claim 2, wherein the operating parameters of the closing unit drive include the tool closing force, the internal mold pressure and/or the tool heat capacity.

16. The injection molding machine according to claim 2, wherein the molding material in the cavity of the injection molding tool comprises a portion of at least 1 vol %, in particular at least 10 vol %, in particular at least 15 vol %, in particular at least 20 vol %, and in particular at least 25 vol % recyclate material, in particular pre-consumer recyclate material or post-consumer recyclate material.

17. The injection molding machine according to claim 2, further including:
one or more temperature sensors, which are disposed in the cavity of the injection molding tool, close to the cavity of the injection molding tool and/or on the plasticizing cylinder (11).

18. The injection molding machine according to claim 2, further including:
one or more pressure sensors, which are disposed in the cavity of the injection molding tool, close to the cavity of the injection molding tool and/or on the plasticizing cylinder.

19. The method according to claim 9, wherein the operating parameters of the closing unit drive include the tool closing force, the internal mold pressure and/or the tool heat capacity.

20. The method according to claim 9, wherein the molding material in the cavity of the injection molding tool comprises a portion of at least 1 vol %, in particular at least 10 vol %, in particular at least 15 vol %, in particular at least 20 vol %, and in particular at least 25 vol % recyclate material, in particular pre-consumer recyclate material or post-consumer recyclate material.
